(19) United States
(12) Patent Application Publication
(10) Pub. No.: US 2016/0192696 A1
(43) Pub. Date: Jul. 7, 2016

(54) APPARATUSES AND METHODS FOR UNIFORMLY APPLYING VARIOUS BREADING AND COATING MATERIALS ON FOOD PRODUCTS

(71) Applicant: MP Equipment, LLC, Gainesville, GA (US)

(72) Inventors: Jerrill H. Sprinkle, Suwanee, GA (US); Richard Mark Phillips, Suwanee, GA (US); Gary Bryan Cowart, McDonough, GA (US); Matthew Todd Palmer, Cleveland, GA (US)

(73) Assignee: MP Equipment, LLC, Gainesville, GA (US)

(21) Appl. No.: 14/987,932

(22) Filed: Jan. 5, 2016

Related U.S. Application Data
(60) Provisional application No. 62/100,705, filed on Jan. 7, 2015.

(51) Int. Cl. A23P 1/08

(52) U.S. Cl. CPC A23P 1/082; A23L 1/005; A23V 2002/00

(57) ABSTRACT

An apparatus for applying a coating material onto the food products includes a machine having a machine framework provided with a conveyor framework for receiving a moving endless conveyor belt arranged to move food products thereon from an input end of the machine to an output end thereof. The machine framework is further configured with a coating material transfer arrangement for coating the food products during movement thereof on the conveyor belt and through the conveyor framework. A shaker assembly is mounted to the machine framework, and is configured with a set of opposed fixtures arranged to oscillate back and forth, and receive food products coated on the conveyor belt between the opposed fixtures and through the shaker assembly such that the coated food products are processed with a uniform coating material texture and released from the shaker assembly to the output end of the machine.

### CROSS REFERENCE TO RELATED APPLICATION

The present utility application relates to and claims priority to U.S. Provisional Patent Application Ser. No. 62/100,705, filed Jan. 7, 2015, which is herein incorporated by reference in entirety.

### FIELD

The present disclosure relates to food processing apparatuses and methods, and more particularly, pertains to a breading machine and methods of use for uniformly applying different types of coating material, such as flour, bread crumbs and cracker meal to food products.

### BACKGROUND

The following U.S. patents and U.S Published Patent application are incorporated by reference in entirety.

U.S. Pat. No. 3,547,075 discloses a machine for coating a food product with breading material having an elevated hopper for storing the breading material, and means for feeding the same in a smooth and controlled manner from the hopper through a free flowing down spout to be deposited on a belt beneath the food product. Further, it includes means for feeding the breading material in a smooth and controlled manner from the hopper to be deposited on top of the food product with a control valve at such outlet to control the rate of feed. A breading level plate is provided to maintain an even layer of breading material beneath the food product on the conveyor belt, and this plate is resiliently mounted to relieve pressure of breading material building up behind the plate. Edge control plates are provided for preventing spillage of breading material at the sides of the conveyor belt. A hooded portion of open mesh belt conveyor is provided near the discharge end of the machine with air spray pipes above the belt to remove excess material, and a hood is adapted to be raised without interrupting the operation of the machine. In a modification, a flip bar is provided across the conveyor belt towards the discharge end of the machine to flip over the product so as to shake off breading material lodging in cavities of the food product together with a novel arrangement for taking up excess length of the belt after it passes over the raised flip bar.

U.S. Pat. No. 5,052,330 discloses a coating machine which includes an endless pervious conveyor belt supported in an elongated frame which provides a food product conveyance path within the machine. A hopper is disposed above the food product conveyance path in which an amount of a coating material is provided to generate a falling curtain of bread crumbs or the like to cover the top and sides of food product pieces passing along the food product conveyance path. The machine also preferably includes a circular drum type conveyor which is rotatably supported along the elongated frame adjacent the hopper, and includes a plurality of pockets formed therein which open into the interior of the machine and the hopper. Conveyors are provided in both the elongated frame and hopper to distribute coating material from the frame enclosure to the circular conveyor which will, in turn, distribute coating material to the hopper to generate the upper layer of breading material. The machine also includes structure to distribute breading material within the frame enclosure so as to continuously and effectively generate a bottom layer of coating material on the food product conveyance path while avoiding congestion of the coating material. The distribution system of the machine is readily adaptable for different kinds of breading materials and allows utilization of the machine for fresh bread crumbs with handling thereof performed in a gentle manner while avoiding congestion or packing of such breading material.

U.S. Pat. No. 5,238,493 discloses a cost effective, simple and sanitary breading machine suitable for coating a variety of food products, such as poultry, with different types of breading materials. After coating of upper and lower surfaces of food products introduced into the breading machine, a significant dwell time within the breading machine is achieved in the construction to allow breading material to more effectively set up on the coated food products. The coating machine further includes structure to enable the food products introduced therein to be flipped a plurality of times, wherein additional coating material is continuously applied to alternate sides of the food products and desirable coating characteristics are achieved. The coating machine and process for coating food products as set forth herein provide a food processor with a means to more effectively and efficiently coat large volumes of food products with breading material without sacrificing desirable characteristics which yield a high quality and more appealing breaded food product.

U.S. Patent Application Publication No. 2006/0156931 discloses a breading machine, and improvements thereto, for use in high volume food production. An improved breading machine includes a side-mounted feed hopper, a low pressure auger assembly including an auger transfer box with an input port for accepting a cross-feed screw and paddle, and an output port for transferring coating material to a vertical screw. The improved breading machine also includes a substantially cylindrical, rod-based spreader assembly and a transport conveyor belt for feeding the spreader assembly within a top hopper of the breading machine. The improved breading machine further includes a vibrating filter assembly to filter out clumps of coating material while allowing un-clumped material to be re-used within the breading machine.

### SUMMARY

Through research and experimentation, the present inventors have determined that the prior art breading and coating machines and methods of use result in:

1) uneven homestyle breading coating texture across food product surfaces produced on drum style breading machines due to food products overlapping in the drum and during discharge from the drum onto a discharge conveyor;

2) downtime or change over time required to either remove the dedicated homestyle breading machine from the production line and install a conventional breading machine, or time required to remove the drum from and reconfigure a breading machine that is capable of running homestyle as well as conventional breading coatings;

3) restricting the breading machine to running only certain types of breaded products; and

4) unbalanced belt coverage across the discharge conveyor of the breading machine due to the inherent, inefficient action of the drum during infeeding and discharge of the food product therefrom.

Through research and experimentation, the present inventors have endeavored to improve upon prior art machines and processes for uniformly applying different types of breading and coating materials on various food products at a very high rate or volume as required in large institutional food processing facilities without the need for any drums or additional machines or removing any components from the machine, or the use of any tools in the food coating process.

In one example, the present disclosure relates to an apparatus for applying a coating material onto food products. The apparatus includes a machine provided with a food product input end and a food product output end, and having a machine framework configured with a conveyor framework for receiving a moving endless conveyor belt arranged to move food products thereon from the food product input end to the food product output end. The machine framework is further configured with a coating material transfer arrangement for coating the food products during movement thereof on the conveyor belt and through the conveyor framework. A shaker assembly is mounted to the machine framework, and is configured with a set of opposed fixtures arranged to oscillate back and forth and receive food products coated on the conveyor belt between the opposed fixtures and through the shaker assembly such that the coated food products are processed with a uniform coating material texture, and released from the shaker assembly to the output end of the machine.

In a further example, the present disclosure relates to a machine which transports food products through a process that creates a uniform homestyle breading coating on various food products by utilizing the force of gravity and two separately opposed horizontally oscillating fixtures in a shaker assembly with interchangeable infinitely designed riffle plates. In the shaker assembly, the distance of the two separately opposed horizontally oscillating fixtures can be adjusted to allow for various size food products along with breading to travel between and through the fixtures, while the two separately opposed horizontally oscillating fixtures cause the food products and breading to flip and bounce back and forth as the force of gravity pulls the food products down between the two fixtures creating the desired homestyle breading coating and discharging the food products evenly across the discharge conveyor. The machine is also capable of running conventional style breading products without the need to remove any components from the machine or the requirement for any tools.

In yet another example, the present disclosure relates to a method for applying a coating to food products comprising the steps of a) providing a machine provided with a food product input end and a food product output end, and a machine framework configured with a conveyor framework for receiving an endless conveyor belt arranged to move food products thereon from the food product input end to the food product output end, the machine framework being further configured with a coating material transfer arrangement for coating the food products during movement thereof on the conveyor belt and through the conveyor framework; b) providing a shaker assembly mounted on the machine framework and configured with a set of opposed fixtures arranged to oscillate back and forth relative to one another and receive food products coated on the conveyor belt; and c) aligning at least a portion of the conveyor framework with the shaker assembly such that the coated food products are introduced into one end of the shaker assembly and processed with a uniform coating texture by means of a flipping and bouncing motion as gravity pulls the coated food products downwardly through the shaker assembly causing the food products to exit from an opposite end of the shaker assembly onto a portion of the conveyor belt outside of the conveyor framework for transport to the output end of the machine.

The method also contemplates the step of d) moving the portion of the conveyor framework out of alignment with the shaker assembly such that the coated food products are delivered externally of the shaker assembly to the portion of the conveyor belt outside of the conveyor framework for transport to the output end of the machine.

### BRIEF DESCRIPTION OF THE DRAWINGS

FIG. 1 is a perspective view of a breading machine in accordance with the present disclosure;

FIG. 1A is an elevational view of the breading machine shown in FIG. 1;

FIG. 2 is a perspective view of the breading machine with portions of an enclosure of the breading machine removed;

FIG. 3 is a diagrammatic side view of one embodiment of the breading machine;

FIG. 4 is a diagrammatic side view of another embodiment of the breading machine shown in FIG. 2;

FIG. 5 is a partial perspective view of the embodiment shown in FIG. 3;

FIG. 6 is a partial enlarged perspective view of the breading machine shown in FIG. 3;

FIG. 7 is a partial enlarged perspective view of the breading machine being moved to the position shown in FIG. 4;

FIG. 8 is a front perspective view of a shaker assembly used in the breading machine;

FIG. 9 is a rear view of FIG. 8;

FIG. 10 is a front view of FIG. 8;

FIG. 11 is a view illustrating horizontal oscillation of opposed fixtures in the shaker assembly; and

FIG. 12 is a view illustrating the adjustment of spacing between the opposed fixtures.

### DETAILED DESCRIPTION

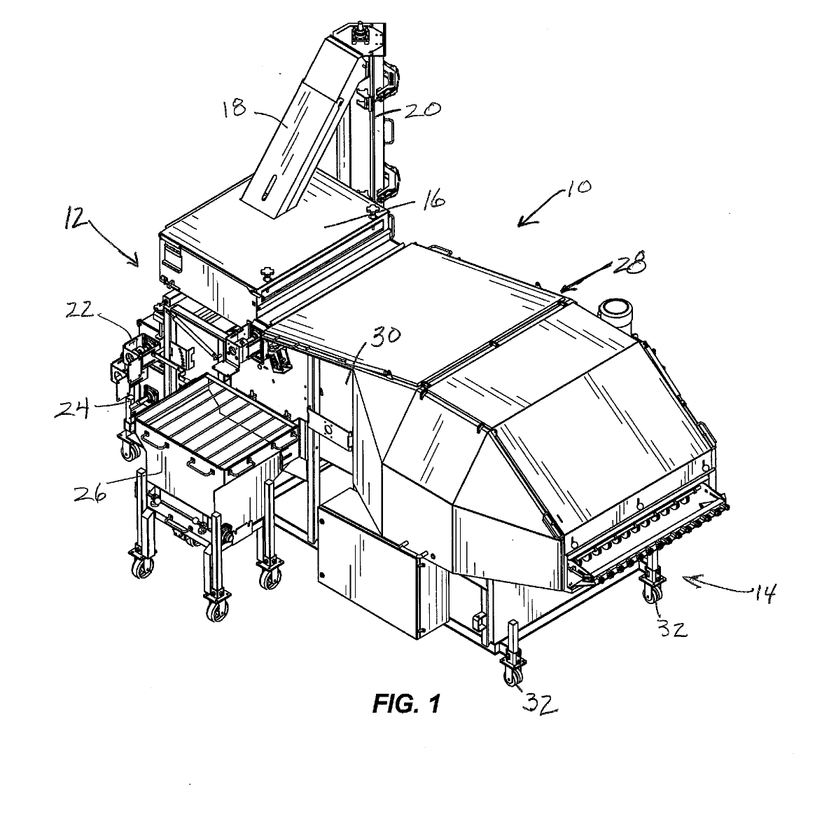

Referring now to the drawings, FIGS. 1-5 illustrate an apparatus in the form of an inline breading machine 10 having an input end 12 and an output end 14. Food products to be coated with a coating material (e.g. flour, bread crumbs, cracker meal) enter the breading machine 10 from the rear or input end 12, and exit from the front or output end 14. The food products are typically fed into the input end 12 via a conveyor belt, for example, such as from equipment (e.g. a batter applicator) which is separate from the breading machine 10. The food products are coated in the machine 10, and are typically fed out of the output end 14 and into another apparatus, such as, for example, a packaging machine, a baking oven or a fryer.

As viewed in FIGS. 1 and 1A, the breading machine 10 includes a top hopper 16, a top hopper chute 18, a vertical transport section 20, first and second horizontal transport sections 22, 24, respectively, a side mounted feed hopper 26, a breading chamber enclosure 28, and a mobile machine framework 30 mounted on casters 32 for supporting the hopper 16, the chute 18, the sections 20, 22, 24, the hopper 26 and the enclosure 28.

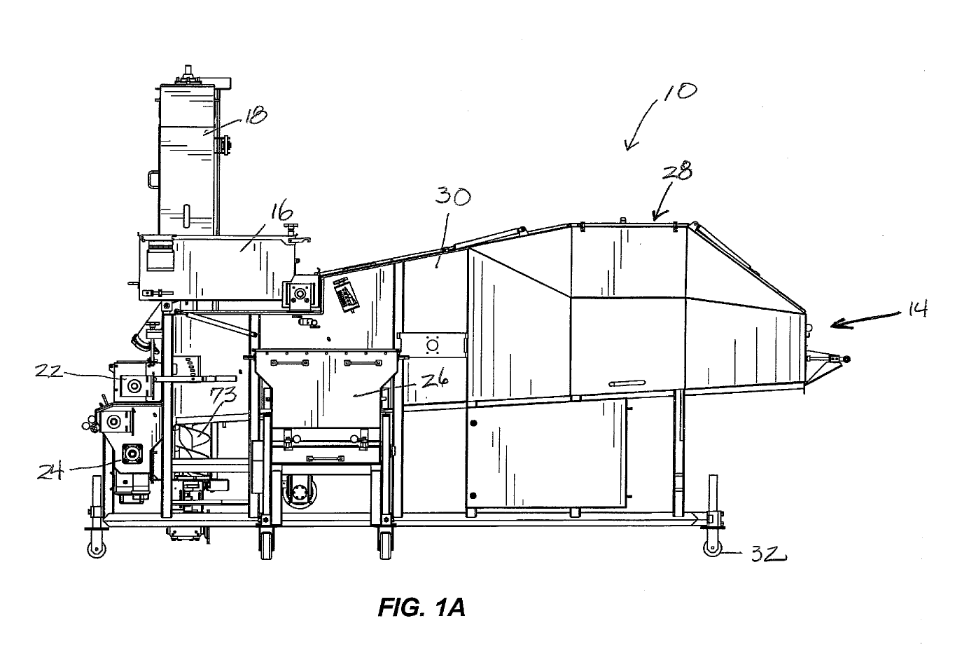

As seen in FIGS. 2-5, the breading machine 10 further includes an endless main conveyor belt 34 which moves through several sections of the framework 30, and carries food products and coating material therethrough via an upper delivery portion 36 of the conveyor belt 34 running in a forward direction as represented by arrows A. The upper delivery portion 36 of conveyor belt 34 travels from a rear end of the machine 10 through a conveyor framework mounted on the framework 30 within the enclosure 28, and defined by an inclined section 38 and a swing arm assembly 40 which is pivotally connected at 41 to the inclined section 38 at a front end thereof. The upper portion 36 of the conveyor belt 34 runs beneath a sprinkle/sifter assembly 42 and a compression roller 44. The sprinkle/sifter assembly 42 is mounted at an output end of the top hopper 16, and is used to spread or sprinkle coating material over the top and sides of the food products traveling on the upper portion 36 of the conveyor belt 34. The compression roller 44 is rotatably mounted on the framework 30 forwardly of the sprinkle/sifter assembly 42, and is designed to engage a coated food product moving along the upper portion of conveyor belt 34 in the inclined section 38.

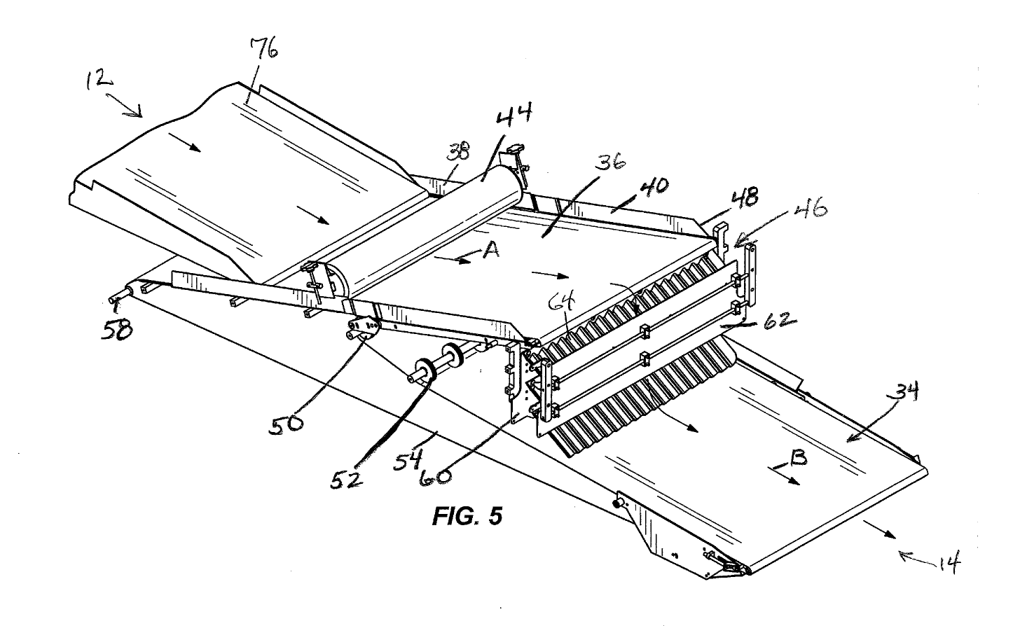

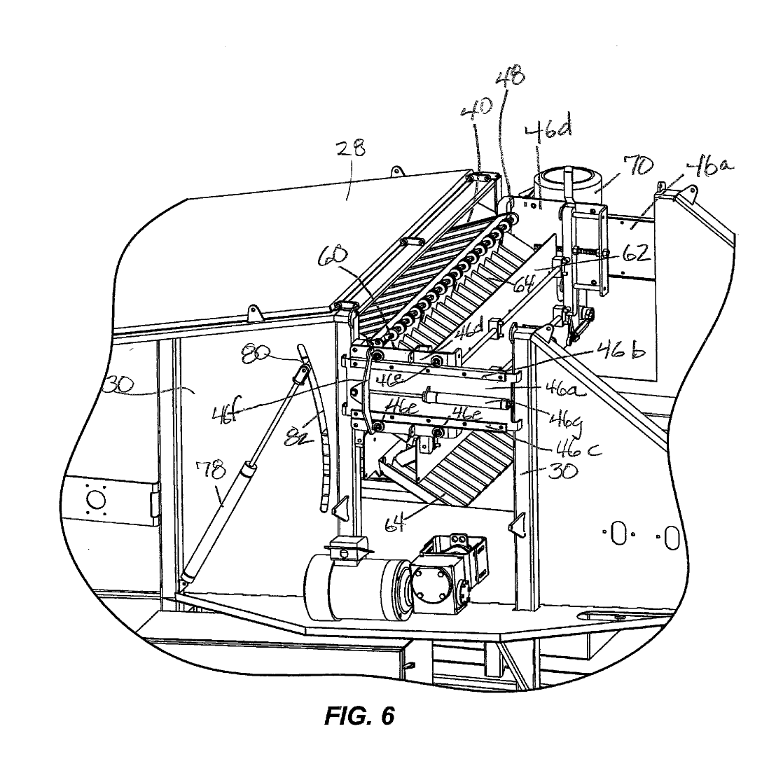

The breading machine 10 also includes a shaker assembly 46 which is movably mounted for linear back and forth positioning on the machine framework 30. As seen in FIGS. 6 and 7, each side of the machine framework 30 has a fixed guide plate 46a which defines upper and lower tracks 46b, 46c. Each side of the shaker assembly 46 is provided with a carriage frame 46d having sets of rollers 46e designed to roll along the tracks 46b, 46c. Each carriage frame 46d includes an attachment bracket, one being seen at 46f in FIGS. 6 and 7. An extendable and retractable cylinder, one being shown at 46g, has a casing end fixed to the framework 30, and a rod end attached to the attachment bracket 46f on each side of the machine 10. By this arrangement, the cylinders 46g can be actuated to move the carriage frames 46d and thus the shaker assembly 46 back and forth along the fixed guide plates 46a of machine framework 30 relative to the output end 48 of the swing arm assembly 40. For example, in FIG. 7, retraction of the cylinder 46g moves the shaker assembly 46 in the direction of arrow D away from the output end 48 of the swing arm assembly 40. The shaker assembly 46 is designed to be positioned in communication with an outer end 48 of the pivotable swing arm assembly 40 such that coated food products being transported on the upper delivery portion 36 of the conveyor belt 34 can be delivered into the shaker assembly 46 for further processing as will be detailed hereafter.

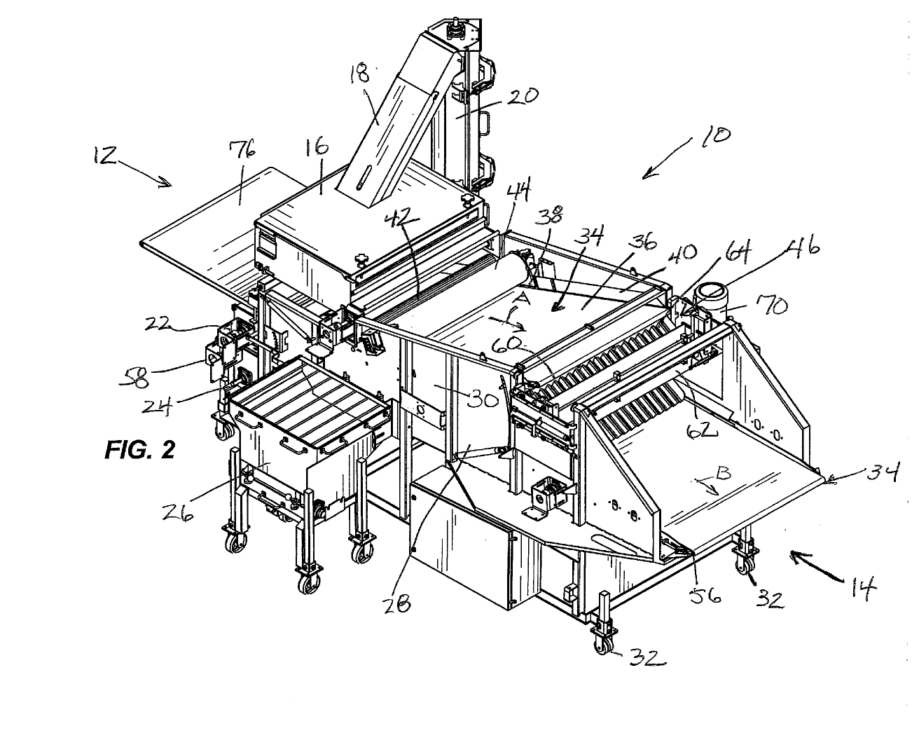

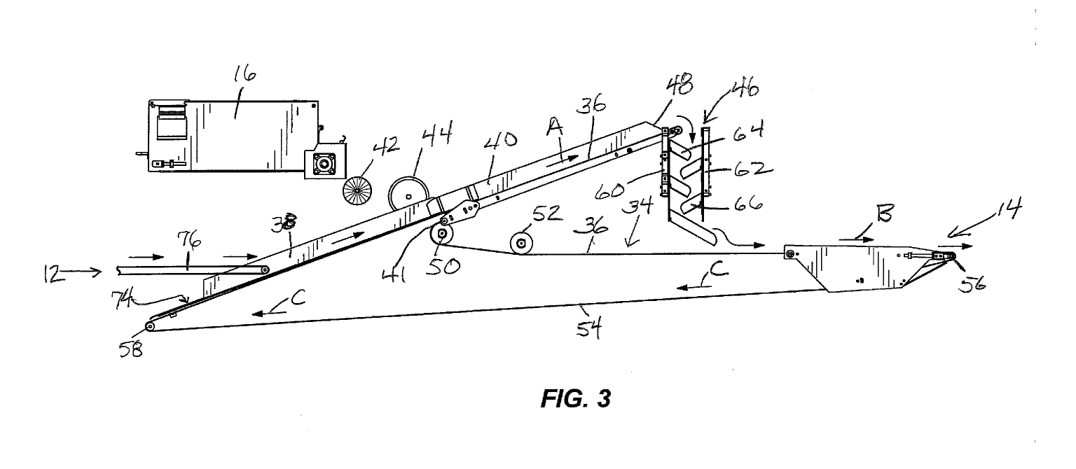

As best seen in FIGS. 3 and 4, the upper delivery portion 36 of the conveyor belt 34 travels around the outer end 48 of and beneath the swing arm assembly 40 back towards the rear end 12 of the machine 10. The conveyor belt 34 then passes around first idler rollers 50 on framework 30 and beneath second idler rollers 52 on framework 30 so that it is directed under the shaker assembly 46, and back towards the front end 14 of the machine 10 in the direction of arrows B so that the coated food products can be discharged from the front or output end 14 of the machine 10. A lower return portion 54 of the conveyor belt 34 travels around an idler roller 56 at the front end of the machine 10, and is directed rearwardly in the direction of arrows C around a drive roller 58 mounted at the rear end of the machine 10. At this point, the conveyor belt 34 is drivingly directed by the drive roller 58 back up the inclined section 38 and the moving conveyor belt cycle repeats.

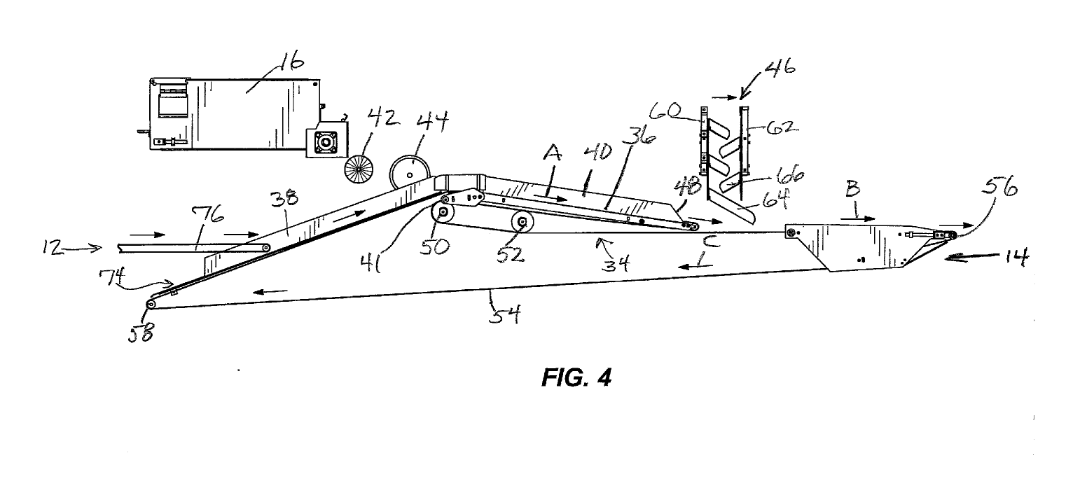

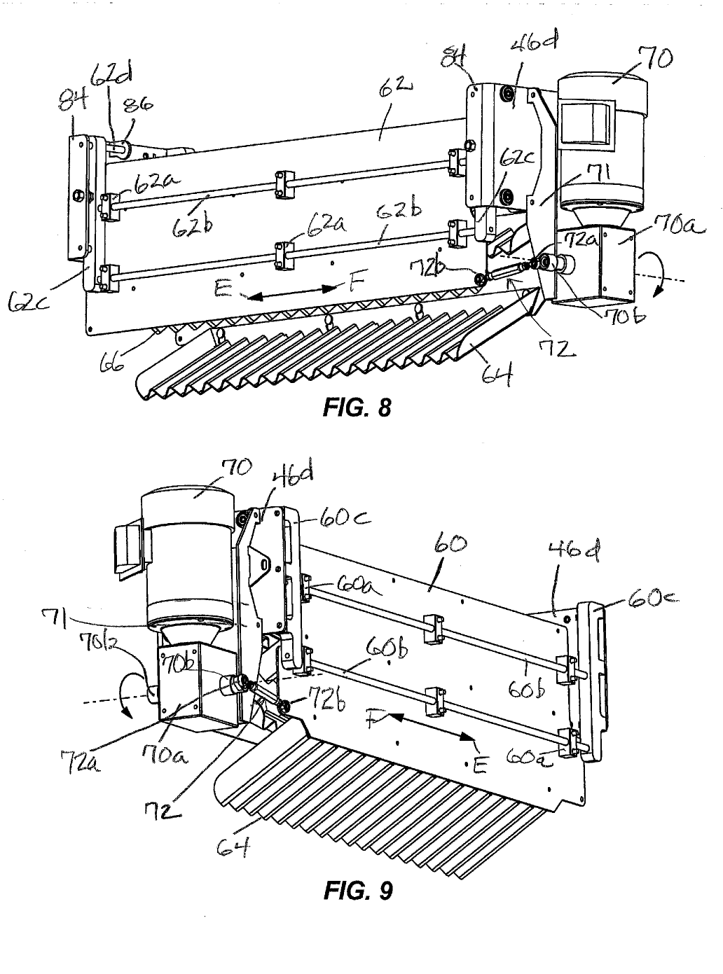

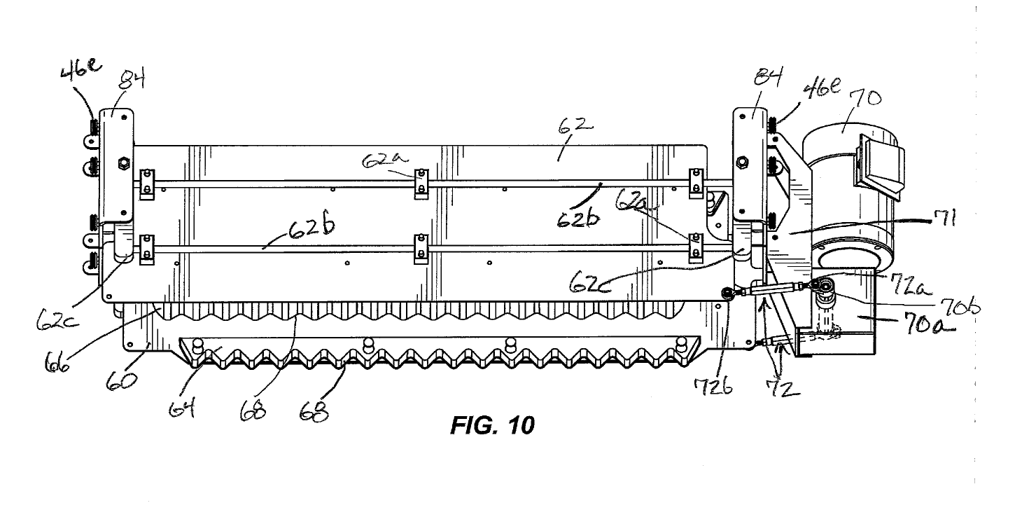

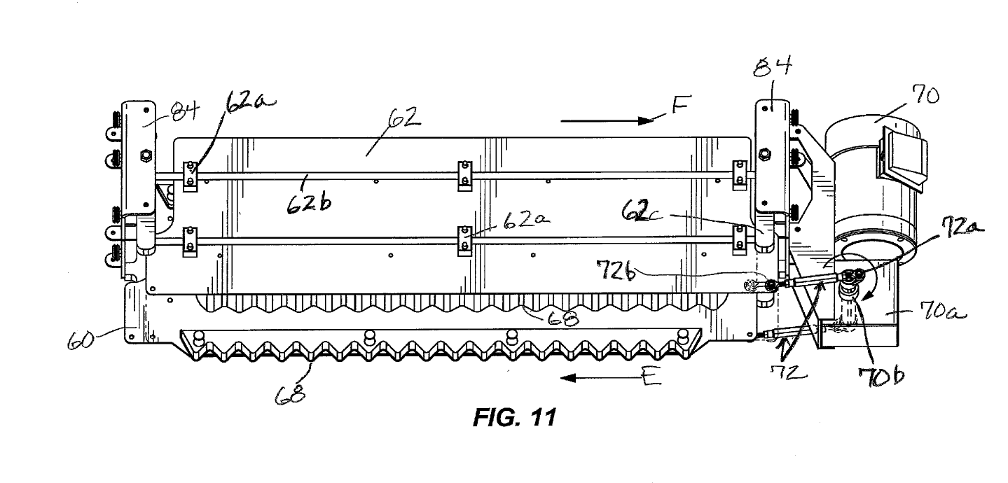

Referring now to FIGS. 5-11, the shaker assembly 46 is configured to extend across the entire width of the conveyor belt 34 at the outer end 48 of the swing arm assembly 40. The shaker assembly 46 includes a pair of spaced apart opposed, vertically oriented and horizontally oscillating planar fixtures 60, 62. The oscillating fixtures 60, 62 are provided with a set of interchangeable opposed riffle plates designed to flip and bounce coated food products introduced into an upper end of the shaker assembly 46 as the coated food products fall by gravity therethrough. In an exemplary embodiment, a number of spaced apart riffle plates 64 extend downwardly and forwardly from fixture 60. A number of spaced apart riffle plates 66 extend downwardly and rearwardly from fixture 62. Each of the riffle plates 64, 66 has an outer edge configured with a linear tooth configuration 68.

The riffle plates 64, 66 are arranged in a staggered overlapping and offset formation such that the angled riffle plates 66 extend between adjacent pairs of the angled riffle plates 64. The distance between the opposed fixtures 60, 62 may be adjusted to allow for variously sized food products with the particular coating materials. The riffle plates 64, 66 may be designed to accommodate a variety of breading or coating textures. In addition, the riffle plates 64, 66 may each be removably mounted to their respective fixtures 60, 62, or the entire assembly of fixtures 60, 62 and riffle plates 64, 66 may be formed as a unit that can be easily removed and replaced with a different desired configuration.

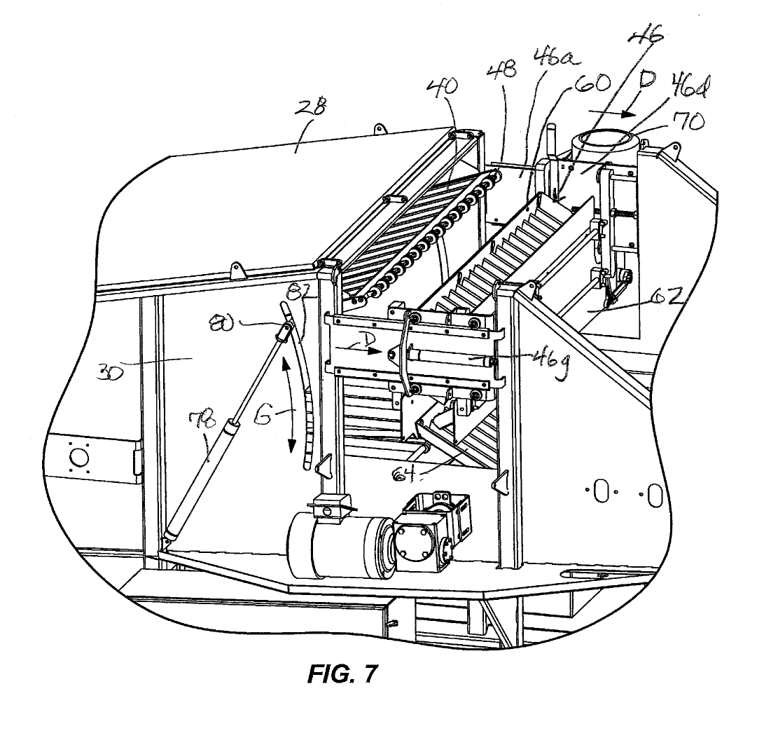

As illustrated in FIGS. 8-11, the fixtures 60, 62 and attached riffle plates 64, 66 are oscillated horizontally back and forth relative to one another by a suitable power drive arrangement. In the examples shown, a motorized cartridge drive 70 is configured to drive a linkage 72 separately connected to the fixtures 60, 62. Such arrangement provides a desired horizontal oscillating motion to increase the contact between the riffle plates 64, 66 and the coated food products deposited into the shaker assembly 46 to remove clumps of excess coating material and provide a consistent breading texture over the entire food product. The cartridge drive 70 includes a gearbox 70a having a double output shaft 70b projecting from each side of the gearbox 70a. The cartridge drive 70 and the gearbox 70a are attached to one of the carriage frames 46d by a mounting bracket arrangement 71. Each linkage 72 has a crank arm 72a eccentrically connected to one of the output shafts 70b, and an opposite end 72b connected to a bottom end of fixtures 60, 62. Each of the fixtures 60, 62 are provided with a number of spaced apart linear bearing blocks 60a, 62a fixed thereto. The bearing blocks 60a, 62a are designed to receive guide rods 60b, 62b which extend between side bars 60c, 60d. The side bars 60c are fixed to the frames 46d, while the side bars 62c are movably adjusted relative to frames 46d for a purpose to be described below. The crank arms 72a are positioned 180° apart from each other such that upon actuation of the cartridge drive 70, the output shafts 70b and the crank arms 72a rotate causing the fixtures 60, 62 and the bearing blocks 60a, 60b attached thereto to oscillate and move back and forth in the opposite directions of arrows E and F relative to one another along the guide rods 60a, 60b.

A method of use of the machine 10 is described as follows.

It should be understood that a coating material is metered in and onto the lower return portion 54 of the conveyor belt 34 from the side mounted feed hopper 26. The coating material deposited on the lower return portion 54 of the conveyor belt 34 is then transitioned into an auger arrangement such as shown at 73 (FIG. 1A) provided in the vertical transport section 20, and the first and second horizontal transport sections 22, 24. Such auger arrangement is designed to deliver one portion of coating material to an upper section of the conveyor belt 36 at 74 (FIG. 3) before food products are introduced onto the belt 34 at the input end 12 of the machine 10, such as by means of transfer conveyor 76 which is not an integral part of the machine 10. This provides a bottom coating for the food products to be moved onto. Another portion of the coating material is transported by the auger arrangement via the vertical transport section 20, and the top hopper feed chute 18 to the top hopper 16. The sprinkle/sifter assembly 42 at the output end of the top hopper 16 is designed to evenly distribute the coating material downwardly onto the food products being carried upwardly on the belt 34 through the inclined section 38. The sprinkle/sifter assembly 42 functions to fully coat the remaining portion of the food products not coated by the bottom coating layer on the belt 34. Such coating material transfer arrangement provided by the feed hopper 26 and the auger arrangement is more fully described in U.S. Patent Application Publication No. 2006/0156931 as published Jul. 20, 2006, which is herein fully incorporated by reference in entirety. The fully coated food products then continue to move on the upper portion 36 of the belt 34 under the compression roller 44 and up the swing arm assembly 40.

FIG. 3 illustrates an exemplary embodiment of the machine 10 which is used in applying a homestyle breading or coating onto the food products. Homestyle coating, such as may be embodied in a spiced flour, has a texture which is known to be heavier than conventional, more free flowing coating material, such as granular dried bread crumbs, and is more susceptible to form clumps when coating food products. In this example, the outer end 48 of the swing arm assembly 40 is raised to a position aligned with the upper end of the shaker assembly 46 so that the homestyle coated food products on the moving conveyor belt 34 are deposited into the shaker assembly 46. The horizontally oscillating fixtures 60, 62 and the riffle plates 64, 66 of the shaker assembly 46 cause the food products coated with the homestyle breading material to flip and bounce back and forth as the force of gravity pulls the vertically tumbling coated food products downwardly. The relative oscillating horizontal motion of the fixtures 60, 62 and the orientation and riffle tooth configuration 68 of the riffle plates 64, 66 are designed to force an interaction with the homestyle coated food products so that coating clumps can be removed and a consistent uniform breading texture can be provided over the entire surface of the food product. Because the shaker assembly 46 extends across the entire width of the conveyor belt 36, the shaken coated food products are dropped evenly across the portion of the conveyor belt 36 running beneath the shaker assembly and are conveyed in the direction of arrows B towards the front and output end 14 of the machine 10 where the uniformly coated and evenly distributed food products are efficiently discharged.

When it is desired to apply a non-homestyle, conventional, more free flowing coating material, such as dried bread crumbs, to food products, the above described machine 10 can be easily modified without replacing/interchanging any components of the machine 10 or using any tools.

FIG. 4 illustrates an exemplary embodiment of the machine 10 which is used in applying such conventional, more free flowing coating material to the food products. The machine 10 shown in FIG. 4 is similar to the machine shown and described FIG. 3 with the exception that the swing arm assembly 40 is pivoted downwardly out of alignment with shaker assembly 46 so that the outer end 48 of the swing arm assembly 40 is placed in communication with the portion of the conveyor belt 34 passing beneath the shaker assembly 46. In this embodiment, the shaker assembly 46 is movable out of aligned communication with the outer end 48 of the swing arm assembly 40 by using the cylinders 46g, and moving the roller-mounted carriage frames 46d along the guide plates 46a as shown in FIG. 7, so that food products provided with non-homestyle coating material supplied from the side feed hopper 26 travel up the inclined section 38, pass under the compression roll 44 and continue downwardly along the swing arm assembly 40. The coated food products exit from the outer end 48 of the swing arm assembly 40 directly onto the conveyor belt 34 outside and beneath the shaker assembly 46, and are transported by the conveyor belt 34 running beneath the shaker assembly 46 to the front or output end 14 and discharged.

It should be appreciated that the swing arm assembly 40 may be selectively pivoted in an automatic manner between the positions shown in FIGS. 3 and 4 by providing a suitable powered raising and lowering device such as a cylinder arrangement 78 (FIGS. 6 and 7) between framework 30 and the swing arm assembly 40 on each side of the machine 10. A rod end of each cylinder arrangement 78 is attached to a projection 80 on each side of the swing arm assembly 40 so that the swing arm assembly 40 can be swung along a curved path G defined by a slot formation, one being seen at 82. As the coated food products approach the output end 14 of the machine 10 in both embodiments of FIGS. 3 and 4, any excess coating material is allowed to fall through the belt 34 and be transported back to the auger arrangement previously described and recycled back into the machine 10.

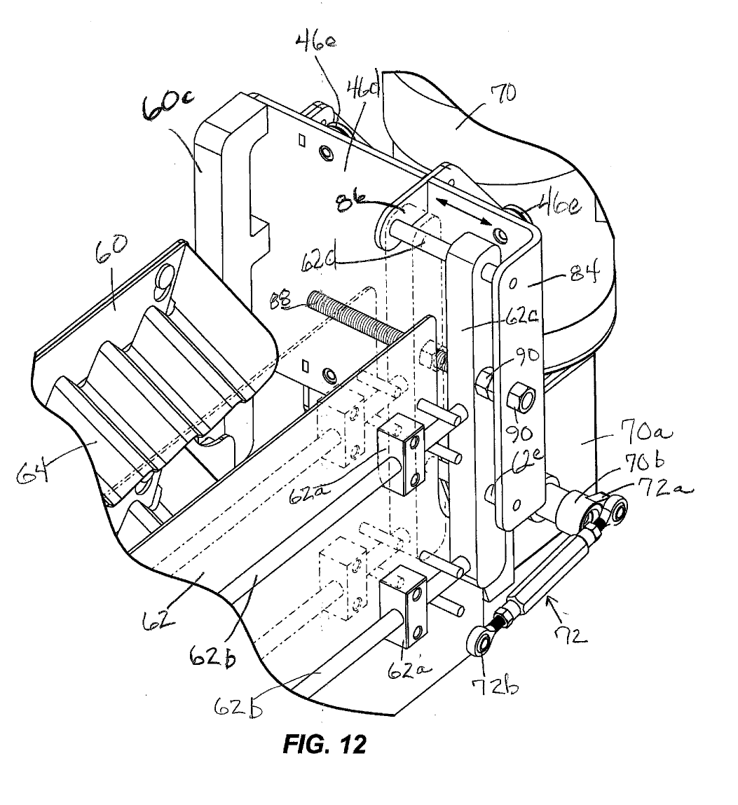

FIG. 12 illustrates an arrangement for selectively adjusting the spacing between the opposed fixtures 60, 62 for differently sized foods passing through the shaker assembly 46. In the example shown, fixture 62 may be adjusted relative to fixture 60 between a maximum spaced position shown in solid lines and a minimum spaced position shown in phantom lines. The side bars 62c (to which fixture 62 is secured) are movably mounted along upper and lower rods 62d, 62e fixed between end walls 84 and support brackets 86. Threaded shafts 88 pass through the side bars 62c and nuts 90. Manipulation of the nuts 90 turns the shafts 88 and causes the fixture 62 to move back and forth relative to fixture 60.

In summary, an improved breading machine 10 is disclosed for uniformly applying different types of coating materials and textures to food products at a very high rate or volume without the need for any additional machines or drum components, without the necessity for removing any components from the machine, and without requiring any tools during the food coating process. The breading machine 10 improves upon prior art food coating machines by eliminating uneven coating material textures across food products, downtime to replace or reconfigure components of a machine or an entire machine, and drums or other cylindrical type rotating devices which restrict a machine to applying only particular coating materials. The breading machine 10 further improves over prior art designs in occupying a smaller footprint that previous coating and breading machines.

The breading machine 10 is capable of applying different textures of coating materials to food products in a highly efficient manner by simply adjusting the position of the swing arm assembly 40 and the shaker assembly 46. When applying heavier texture coating materials to food products, the oscillating nature of the fixtures 60, 62 and the particular configuration of the riffle plates 64, 66 in the shaker assembly 46 proves to be extremely effective in providing a consistent finished coating texture on the food products

In the present disclosure certain terms have been used for brevity, clearness, and understanding. No unnecessary limitations are to be inferred therefrom beyond the requirement of the prior art because such terms are used for descriptive purposes and are intended to be broadly construed. The different configurations, systems, and method steps described herein may be used alone or in combination with other configurations, systems and method steps. It is to be expected that various equivalents, alternatives and modifications are possible within the scope of the appended claims.

What is claimed is:

1. An apparatus for applying a coating material onto food products, the apparatus comprising:
a machine provided with a food product input end and a food product output end, and having a machine framework configured with a conveyor framework for receiving a moving endless conveyor belt arranged to move food products thereon from the food product input end to the food product output end, the machine framework being further configured with a coating material transfer arrangement for coating the food products during movement thereof on the conveyor belt and through the conveyor framework; and
a shaker assembly mounted to the machine framework, and configured with a set of spaced apart opposed fixtures arranged to oscillate back and forth relative to one another and receive food products coated on the conveyor belt between the opposed fixtures and through the shaker assembly such that the coated food products are processed with a uniform coating material texture, and released from the shaker assembly to the output end of the machine.

2. The apparatus of claim 1, wherein, in a first configuration, a portion of the conveyor framework is movable into alignment with the shaker assembly such that the coated food products are introduced into one end of the shaker assembly and processed between the oscillating fixtures by means of a flipping and bouncing motion as gravity pulls the coated food products downwardly through the shaker assembly causing the food products to exit from an opposite end of the shaker assembly onto a portion of the conveyor belt outside of the conveyor framework for transport to the output end of the machine, and
wherein, in a second configuration, the portion of the conveyor framework is movable out of alignment with the shaker assembly such that coated food products from the conveyor framework are delivered externally of the shaker assembly to the portion of the conveyor belt outside of the conveyor framework for transport to the output end of the machine.

3. The apparatus of claim 1, wherein the conveyor framework includes an inclined section, and a swing arm assembly pivotally connected to the inclined section.

4. The apparatus of claim 3, wherein the machine framework is provided with a sprinkle/sifter assembly and a compression roller which are mounted above the inclined section of the conveyor framework.

5. The apparatus of claim 4, wherein the conveyor belt has an upper delivery portion which runs in a forward direction from a rear end of the machine along an upper surface of the inclined section and the swing arm assembly beneath the sprinkle/sifter assembly and the compression roller, travels in a rearward direction beneath the swing arm assembly, and then moves in the forward direction beneath the shaker assembly towards a front end of the machine.

6. The apparatus of claim 5, wherein the conveyor belt has a lower return portion which is connected with the upper delivery portion and travels in the rearward direction from the front end of the machine to the rear end of the machine.

7. The apparatus of claim 5, wherein the conveyor belt is driven by a drive roller positioned at the rear end of the machine.

8. The apparatus of claim 5, wherein the swing arm assembly is pivotable between a first position aligned with an upper end of the shaker assembly, and a second position located out of alignment with the upper end of the shaker assembly and adjacent the upper delivery portion of the conveyor belt located beneath the swing arm assembly.

9. The apparatus of claim 1, wherein the shaker assembly is movably mounted for back and forth movement on the machine framework relative to the conveyor belt and the conveyor framework.

10. The apparatus of claim 1, wherein the set of opposed fixtures of the shaker assembly is a pair of spaced apart, vertically oriented fixtures configured for horizontal oscillation relative to each other.

11. The apparatus of claim 1, wherein the pair of opposed fixtures includes a set of interchangeable opposed riffle plates.

12. The apparatus of claim 11, wherein a first one of the fixtures includes a first set of angled riffle plates extending downwardly and forwardly from the one of the fixtures, and the second one of the fixtures includes a second set of angled riffle plates extending downwardly and forwardly from the second one of the fixtures.

13. The apparatus of claim 12, wherein the first and second sets of riffle plates are arranged in staggered overlapping and offset formation such that the second set of riffle plates extends between adjacent pairs of the first set of riffle plates.

14. The apparatus of claim 1, wherein an adjustment arrangement is provided on the shaker assembly to vary a distance between the opposed fixtures.

15. The apparatus of claim 11, wherein each of the riffle plates is formed with a tooth configuration.

16. The apparatus of claim 1, wherein the shaker assembly includes a drive arrangement for selectively oscillating the opposed fixtures, the drive arrangement including a motorized cartridge drive, a gearbox operably connected to the cartridge drive, a pair of output shafts projecting from the gearbox, and a linkage connecting each of the output shafts to each of the opposed fixtures.

17. In a machine provided with a food product input end and a food product output end, and having a machine framework configured with a conveyor framework for receiving a moving endless conveyor belt arranged to move food products thereon from the food product input end to the food product output end, the machine framework being further configured with a coating material transfer arrangement for coating the food products during movement thereof on the conveyor belt and through the conveyor framework, an arrangement for processing the food products coated on the conveyor belt comprising:
a shaker assembly having a pair of spaced apart opposed fixtures mounted on the framework and configured to oscillate back and forth relative to one another, and receive food products coated on the conveyor belt between the opposed fixtures and through the shaker assembly such that the coated food products are processed with a uniform coating material texture, and released from the shaker assembly to the output end of the machine.

18. The arrangement of claim 17, wherein the shaker assembly is mounted for back and forth movement on the machine framework relative to the conveyor framework.

19. The arrangement of claim 17, wherein the shaker assembly is configured for movement between a first position in aligned communication with an outer end of the conveyor framework, and a second position removed from aligned communication with the outer end of the conveyor framework.

20. A method for applying a coating to food products comprising the steps of:
a) providing a machine provided with a food product input end and a food product output end, and a machine framework configured with a conveyor framework for receiving an endless conveyor belt arranged to move food products thereon from the food product input end to the food product output end, the machine framework being further configured with a coating material transfer arrangement for coating the food products during movement thereof on the conveyor belt and through the conveyor framework;
b) providing a shaker assembly mounted on the machine framework and configured with a set of opposed fixtures arranged to oscillate back and forth relative to one another and receive food products coated on the conveyor belt; and
c) aligning at least a portion of the conveyor framework with the shaker assembly such that the coated food products are introduced into one end of the shaker assembly with a uniform coating texture and processed by means of a flipping and bouncing motion as gravity pulls the coated food products downwardly through the shaker assembly causing the food products to exit from an opposite end of the shaker assembly onto a portion of the conveyor belt outside of the conveyor framework for transport to the output end of the machine.

21. The method of claim 20, including the step of:
d) moving the portion of the conveyor framework out of alignment with the shaker assembly such that the coated food products from the conveyor framework are delivered externally of the shaker assembly to the portion of the conveyor belt outside of the conveyor framework for transport to the output end of the machine.
